(19) United States
(12) Patent Application Publication
(10) Pub. No.: US 2014/0172429 A1
(43) Pub. Date: Jun. 19, 2014

(54) LOCAL RECOGNITION OF CONTENT

(71) Applicant: MICROSOFT CORPORATION, Redmond, WA (US)

(72) Inventors: THOMAS C. BUTCHER, SEATTLE, WA (US); KAZUHITO KOISHIDA, REDMOND, WA (US); IAN STUART SIMON, SAN FRANCISCO, CA (US)

(73) Assignee: MICROSOFT CORPORATION, REDMOND, WA (US)

(21) Appl. No.: 13/715,240

(22) Filed: Dec. 14, 2012

(51) Int. Cl. G10L 19/018

(52) U.S. Cl. CPC G10L 19/018
USPC 704/270

(57) ABSTRACT

Systems, methods, and computer-readable storage media for facilitating local recognition of audio content at a user device. In some embodiments, the method includes capturing, using a user device, audio data, at least some of which is processable to recognize the audio data. Thereafter, an audio fingerprint that uniquely represents perceptual information associated with the audio data is generated, and a local data store within the user device is referenced. Such a local data store can include reference audio fingerprints. Upon referencing the local data store, a determination can be made as to whether the generated audio fingerprint matches a reference audio fingerprint at least to an extent.

### BACKGROUND

Audio content recognition programs traditionally operate by capturing audio data using device microphones and submitting queries to a server that includes a searchable database. The server is then able to search its database, using the audio data, for information associated with content from which the audio data was captured. Such information can then be returned for consumption by the device that sent the query. Accessing a remote searchable database to perform audio recognition, however, utilizes both network resources and cloud computing resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable storage media for, among other things, locally recognizing audio content. In this regard, audio content (e.g., TV and radio) can be recognized via the user device without accessing a separate computing component to perform the content recognition. In embodiments, to perform such local content recognition, the user device, or a portion thereof, performs audio fingerprint generation for captured audio content and employs a local fingerprint data store to recognize audio content.

### BRIEF DESCRIPTION OF THE DRAWINGS

The present invention is illustrated by way of example and not limited in the accompanying figures in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 depicts a timeline of an example implementation that describes audio capture in accordance with one or more embodiments;

FIG. 4 is a flow diagram showing an exemplary first method for facilitating local content recognition, in accordance with an embodiment of the present invention;

FIG. 5 is a flow diagram showing an exemplary second method for facilitating local content recognition, in accordance with an embodiment of the present invention; and

FIG. 6 is a flow diagram showing an exemplary method for obtaining embeddable code, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable storage media for, among other things, locally recognizing audio content. In this regard, audio content (e.g., TV and radio) captured by a user device can be locally recognized without requiring the user device to access a content recognition component remote from the user device. To locally recognize audio content, various embodiments enable captured audio, such as music content, to be fingerprinted and such a fingerprint(s) matched to a fingerprint data store residing at the user device.

Accordingly, one embodiment of the present invention is directed to a computer-implemented method for facilitating local recognition of audio content at a user device. The method includes capturing, using a user device, audio data, at least some of which is processable to recognize the audio data. Thereafter, an audio fingerprint that uniquely represents perceptual information associated with the audio data is generated. A local data store within the user device is referenced. Such a local data store includes reference audio fingerprints. A determination can then be made that the generated audio fingerprint matches a reference audio fingerprint at least to an extent.

Another embodiment of the present invention is directed to a mobile device that includes a microphone configured facilitate audio data capture. The mobile device also includes a listening control configured to store captured audio data in a buffer prior to receiving a user input associated with a request for information regarding the audio data. The mobile device further includes a fingerprint generating component configured to generate fingerprints from the audio data. In addition, the mobile device includes a content recognizer configured to access a local data store containing a plurality of reference fingerprints and compare the generated fingerprints to one or more of the plurality of reference fingerprints to recognize the audio data.

In yet another embodiment, the present invention is directed to one or more computer-readable storage media storing computer-useable instructions that, when used by one or more computing devices, cause the one or more computing devices to perform a method for facilitating local recognition of audio content. The method includes initiating background listening to recognize audio content. Background listening includes continually buffering audio data and generating audio fingerprints from the buffered audio data, and periodically determining if audio content is recognized using the generated audio fingerprints and a set of locally stored reference fingerprints. An indication of recognized audio content is received and, based on the recognized audio content, an event to initiate is identified. Thereafter, the identified event is initiated.

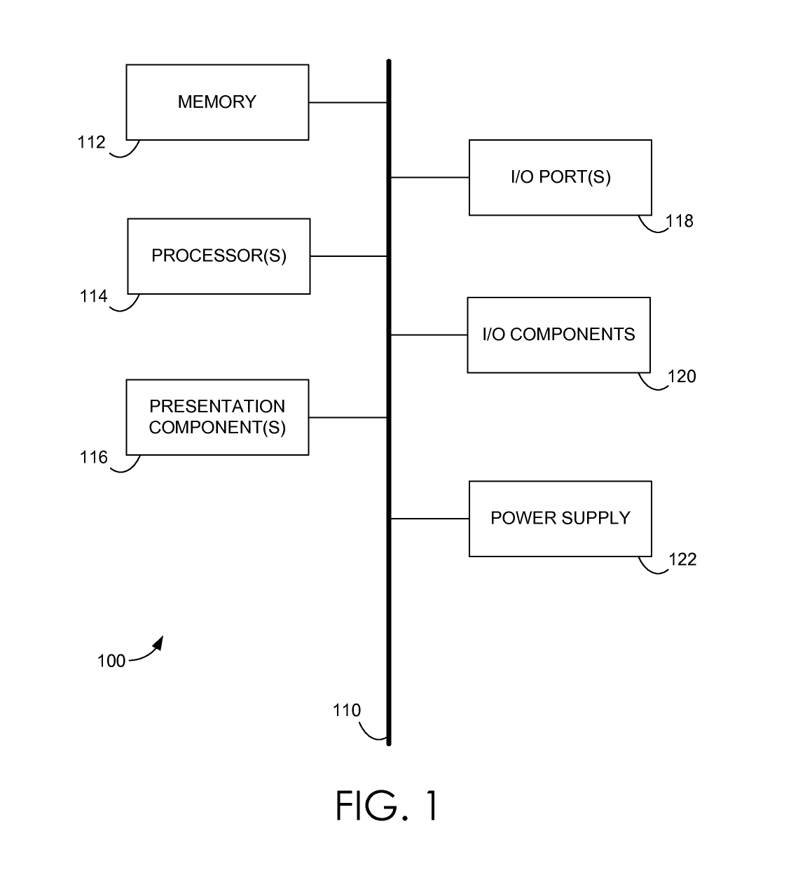

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

As previously mentioned, embodiments of the present invention relate to systems, methods, and computer-readable storage media for, among other things, facilitating local recognition of content. In this regard, audio content (e.g., TV, radio, and web content) can be locally recognized using a user's device. To locally recognize audio content, various embodiments of the invention enable user devices, or portions thereof, to generate fingerprints and recognize audio content using a local fingerprint data store (e.g., database). In this regard, as audio content is being presented, audio fingerprints for such content can be generated and used to recognize the audio content by comparing the generated fingerprints associated with the audio content to fingerprints stored in a data store local to the user device. By locally recognizing audio content, upon a user device capturing audio content, the user device does not need to access a network to identify the audio content. That is, audio content can be recognized via a user device without the user device accessing a remote or separate server or other computing device.

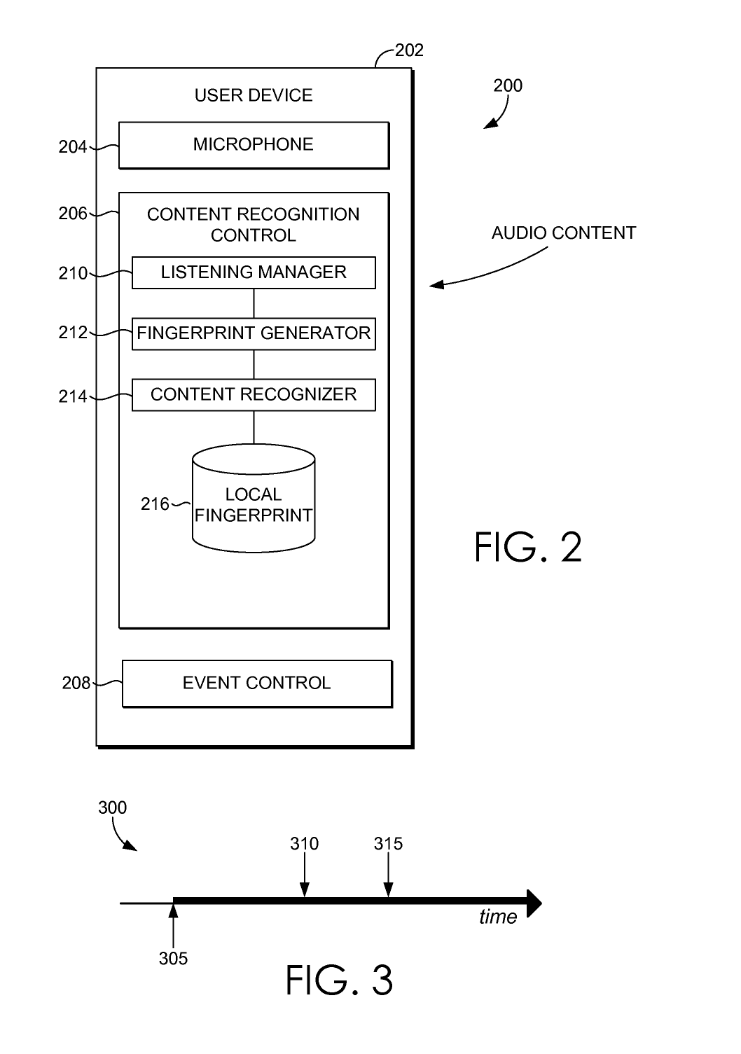

Referring now to FIG. 2, a block diagram is provided illustrating an exemplary computing environment 200 in which embodiments of the present invention may be employed. Generally, the computing environment 200 illustrates an environment in which audio content can be locally recognized. Among other components not shown, the user device 202 within the computing environment 200 generally includes a microphone 204, a content recognition control 206, and an event control 208. The user device 202 may be any computing device, such as computing device 100 of FIG. 1. As such, the user device 202 may be any suitable type of device, such as a laptop, a tablet, a desktop computer, a set-top box, a mobile device (e.g., a mobile phone, a portable music player, a personal digital assistant, a dedicated messaging device, a portable game device, a netbook, or the like), or any other computing device capable of recognizing content.

In some embodiments, one or more of the illustrated components/modules may be implemented as stand-alone applications. In other embodiments, one or more of the illustrated components/modules may be implemented via an operating system or application running on a user device. In this regard, one or more of the illustrated components/modules may be code or data integrated with a computing device's operating system or an application(s) running on the user device. For example, components of the content recognition control 206 and/or the event control 208 can be embedded into an application(s) or operating system running on the user device. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

In operation, audio content is presented, for example, via an audio source (not shown). The user device 202, such as the microphone 204, can be used to capture audio data associated with the presented audio content. That is, audio data can be captured via a microphone, such as microphone 204 of user device 202. Audio data can be captured in other ways, depending on the specific implementation, and a microphone is not intended to limit the scope of embodiments of the present invention. For example, the audio data can be captured from a streaming source, such as an FM or HD radio signal stream.

The content recognition control 206 facilitates local content recognition. In embodiments, the content recognition control 206 includes a listening manager 210, a fingerprint generator 212, a content recognizer 214, and a local fingerprint data store 216. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof.

In some embodiments, the content recognition control 206, or a portion thereof, resides within an operating system of the user device 202. In other embodiments, the content recognition control 206, or a portion thereof, functions in association with an application running on the user device 202. In one implementation, a content recognition application's code can include embedded code that is utilized to implement the functionality described in the content recognition control 206, or a portion thereof. A content recognition application might be any application that utilizes functionality of content recognition. By way of example, a content recognition application may be an application with a general purpose or intent of recognizing content. That is, a content recognition application may be application having a primary purpose of recognizing audio content. In another example, a content recognition application may be an application having a portion of functionality that is intended to recognize content (e.g., specific content associated with the application) or that accesses another component, application, or operating system of the user device that recognizes content. For example, assume an application associated with an entity purpose is to promote or support the entity, or an endeavor thereof. Further assume that the application includes functionality to recognize a set of one or more jingles or other audio clips associated with the entity. Such an application may be referred to as a content recognition application. That is, the application is capable of recognizing content. In another implementation, functionality of the content recognition control 206, or a portion thereof, is performed by a stand-alone application that, for example, may be accessed or referenced by another program, such as another application running on the user device.

The listening manager 210 facilitates audio listening and/or control thereof. In this regard, the listening manager 210 can facilitate storing and/or buffering audio data in a buffer. Audio data may be stored in the form of audio samples. Such audio data can be stored in a data store, such as a database, memory, or a buffer. This can be performed in any suitable way and can utilize any suitable database, buffer, and/or buffering techniques. For instance, audio data can be continually added to a buffer, replacing previously stored audio data according to buffer capacity. By way of example, the buffer may store data associated with the last minute of audio, last five minutes of audio, last ten minutes of audio, depending on the specific buffer used and device capabilities.

In one embodiment, audio data is buffered upon receiving user input associated with audio data capture. In this regard, upon a user inputting an indication to utilize content recognition services, the audio data is captured and buffered. For example, upon a user providing an indication that audio data capture is desired (e.g., select an “Identify Content” icon or button), audio data is captured and buffered and, thereafter, utilized to recognize audio content, as described in more detail below.

In another embodiment, the listening manager 210 manages background listening. In this regard, audio data is captured and buffered prior to receiving user input associated with audio data capture. As such, prior to a user inputting an indication to utilize content recognition services, the audio data is captured and buffered. For example, prior to a user providing an indication that audio data capture is desired (e.g., select an “Identify Content” icon or button or other indication that particular content is to be the subject of content recognition), audio data is captured and buffered. This helps reduce the latency between when a user indicates that content recognition services are desired and the time audio content is recognized. In some embodiments, the listening manager 210 performs such background listening. In other embodiments, the listening manager 210 initiates background listening, for example, by providing a command to another component to perform such functionality.

Background listening can occur at or during a number of different times. For instance, background listening can be activated at times when a device is in a low-power state or mode. In a low-power mode, a user device is on and active but not performing in a fully activated state. For example, a low-power mode may exist when a user device is being carried by a user, but not actively used by the user. Alternatively or additionally, background listening can be activated during a user's interaction with the user device, such as when a user is sending a text or email message. Alternatively or additionally, background listening can be activated while an application, such as a content recognition application, is running or being launched.

FIG. 3 depicts a timeline 300 of an example implementation that describes audio data capture in accordance with one or more embodiments utilizing background listening. In this timeline, the dark black line represents time during which audio data is captured by the device. There are a number of different points of interest along the timeline. For example, point 305 depicts the beginning of audio data capture in one or more scenarios, point 310 depicts the launch of a content recognition application, and point 315 depicts a user interaction with a user instrumentality, such as an “Identify Content” tab or button.

In one or more embodiments, point 305 can be associated with different scenarios that initiate the beginning of audio capture. For example, point 305 can be associated with activation of a device (e.g., when the device is turned on or brought out of standby mode). Alternatively or additionally, point 305 can be associated with a user's interaction with the mobile device, such as when the user picks up the device, sends a text or email message, and/or the like. For example, a user may be sitting in a café with the device sitting on the table. While the device is motionless, it may not, in some embodiments, be capturing audio data. However, the device can begin to capture audio data when the device is picked up, when the user interacts with a user interface element of the user device, when the user initiates or launches an application, such as a mobile browser or text messaging application.

At point 310, the user launches the content recognition application. For example, the user may hear a song in the café and would like information on the song, such as the title and artist of the song. After launching the content recognition application, the user may interact with a user instrumentality, such as the “Identify Content” tab or button at point 315. Thereafter, content recognition proceeds as described in more detail below. Because audio data has been captured in the background prior to the user indicating a desire to receive information or content associated with a song (at point 315), the time consumed by this process has been dramatically reduced, thereby enhancing the user's experience.

In one or more other background listening embodiments, audio data capture can occur starting at pointing 310 when a user launches a content recognition application. For example, a user may be walking through a shopping mall, hear a song, and launch the content recognition application. By launching the content recognition application, the user device may infer that the user is interested in obtaining information about the song. Thus, by initiating audio data capture when the content recognition application is launched, additional audio data can be captured as compared to scenarios in which audio data capture initiates when the user actually indicates to the device that he or she is interested in obtaining information about the song via the user instrumentality. Again, efficiencies are achieved and the user experience is enhanced because the time utilized to recognize content is reduced by utilizing previously captured audio.

Although FIG. 3 illustrates launching of a content recognition application and user interaction with a content recognition application, embodiments of present invention are not limited to such implementations as will be more apparent below. For example, in some embodiments, continuous background listening can occur along with content recognition even if user interaction with a content recognition application does not occur and/or, in some cases, even if the content recognition application is not launched.

Returning to FIG. 2, upon capturing audio data, the fingerprint generator 212 generates, computes, or extracts audio fingerprints. An audio fingerprint refers to a perceptual indication of a piece or portion of audio content. In this regard, an audio fingerprint is a unique representation (e.g., digital representation) of audio characteristics of audio in a format that can be compared and matched to other audio fingerprints. As such, an audio fingerprint can identify a fragment or portion of audio content. In embodiments, an audio fingerprint is extracted, generated, or computed from a buffered audio sample or set of audio samples, where the fingerprint contains information that is characteristic of the content in the sample(s). In this way, the fingerprint generator 212 processes audio data in the form of audio samples of captured audio content. Any suitable quantity of audio samples can be processed.

In some embodiments, fingerprints are generated in accordance with a user indication to request content identification. In this regard, upon a user, for example, providing an indication that audio data capture is desired (e.g., select an “Identify Content” icon, button, or other indication that particular content is to be the subject of content recognition), a fingerprint(s) can be generated using previously captured audio data or using audio data captured in response to the user selection. For example, the user may be at a live concert and hear a particular song of interest. Responsive to hearing the song, the user can launch, or execute, an audio recognition capable application and provide input via an “Identify Content” instrumentality that is presented on the user device via the user interface 228. Such input indicates that audio data capture is desired and/or that information associated with the audio data is requested. The fingerprint generator 212 can then extract a fingerprint(s) using the captured audio data, or a portion thereof.

In other embodiments, fingerprints are automatically generated at some point(s) after background listening is initiated based on a fingerprint generating event. For instance, assume that audio data is captured via background listening when the user device is active (even if a content recognition application is not utilized). In such a case, a fingerprint(s) may be produced at a single instance or upon a time interval occurrence (e.g., every five seconds) after a fingerprint generation event, such as launching or initiating the content recognition application or another application. Processing overhead is reduced during background listening by simply capturing and buffering the audio data, and not extracting fingerprints from the data. The buffer can be configured to maintain a fixed amount of audio data in order to make efficient use of the device's memory resources. Once a fingerprint generating event is detected, such as receiving an indication to launch an application or a request for information regarding the audio data, also sometimes referred to herein as content information, the most recently-captured audio data can be obtained from the buffer and processed by the fingerprint generator 212. More specifically, assume a user selects to launch a content recognition application while background listening is performed. In response, the fingerprint generator 212 can process the captured audio data and extract a fingerprint(s).

In yet other embodiments, fingerprints are automatically generated, for instance, upon a lapse of a time interval (e.g., fingerprint generating duration). That is, following a time duration (e.g., every five seconds), a fingerprint may be generated based on the most recently captured audio data, or portion thereof. In some cases, fingerprints are automatically generated in accordance with audio data being captured. That is, when audio data is captured (e.g., using a particular background listening implementation), fingerprints are automatically generated (e.g., upon a lapse of a time duration). By way of example only, assume that audio data is captured via background listening when the user device is active (even if a content recognition application is not utilized). In such a case, a fingerprint may be produced every five seconds in accordance with the ongoing background listening.

Audio fingerprints can be generated or extracted in any number of ways and generation thereof is not intended to limit the scope of embodiments of the present invention. Any suitable type or variation of fingerprint extraction can be performed without departing from the spirit and scope of embodiments of the present invention. Generally, to generate or extract a fingerprint, audio features or characteristics are computed and used to generate the fingerprint. Any suitable type of feature extraction or computation can be performed without departing from the spirit and scope of embodiments of the present invention. Audio features may be, by way of example and not limitation, genre, beats per minute, mood, audio flatness, Mel-Frequency Cepstrum Coefficients (MFCC), Spectral Flatness Measure (SFM) (i.e., an estimation of the tone-like or noise-like quality), prominent tones (i.e., peaks with significant amplitude), rhythm, energies, modulation frequency, spectral peaks, harmonicity, bandwidth, loudness, average zero crossing rate, average spectrum, and/or other features that can represent a piece of audio.

As can be appreciated, various pre-processing and post-processing functions can be performed prior to and following computing one or more audio features that are used to generate an audio fingerprint. For instance, prior to computing audio features, audio samples may be segmented into frames or sets of frames with one or more audio features computed for every frame or sets of frames. Upon obtaining audio features, such features (e.g., features associated with a frame or set of frames) can be aggregated (e.g., with sequential frames or sets of frames). In this regard, an audio sample can be converted into a sequence of relevant features. In embodiments, a fingerprint can be represented in any manner, such as, for example, a feature(s), an aggregation of features, a sequence of features (e.g., a vector, a trace of vectors, a trajectory, a codebook, a sequence of indexes to HMM sound classes, a sequence of error correcting words or attributes). By way of example, a fingerprint can be represented as a vector of real numbers or as bit-strings.

Upon generating a fingerprint(s), the content recognizer 214 recognizes whether the fingerprint matches any locally stored fingerprints. In this regard, the content recognizer 214 can access the local fingerprint data store 216 to identify or detect a fingerprint match between a fingerprint generated by the user device and a reference fingerprint within the local fingerprint data store 216. In this regard, the content recognizer 214 can search or initiate a search of the local fingerprint data store 216 to identify fingerprint data, or a portion thereof, that matches or substantially matches (e.g., exceeds a predetermined similarity threshold) fingerprint data generated by the fingerprint generator 212 of the user device 202.

The content recognizer 214 can utilize an algorithm to search the local fingerprint data store 216 of fingerprints, or data thereof, to find a match or substantial match. Any suitable type of searchable information can be used. For example, searchable information may include fingerprints or data associated therewith, such as spectral peak information associated with a number of different songs. In some implementations, a best matched audio content can be identified by a linear scan, beam searching, or hash function of the fingerprint index.

Upon detecting a matching fingerprint, a substantially matching fingerprint (e.g., that exceeds a similarity threshold), or a best-matched fingerprint, content information associated with such a fingerprint can be obtained (e.g., looked-up or retrieved). Content information can include, by way of example and not limitation, displayable information such as a song title, an artist, an album title, lyrics, a date the audio clip was performed, a writer, a producer, a group member(s), a content identifier (e.g., a unique value, numeral, text, symbol, icon, etc.), and/or other information describing or indicating the content. Such content information may be stored in a data store, such as, for example, local fingerprint data store or other locally accessible data store. Content information associated with the matching, substantially matching, or best-matched fingerprint can be provided to the event control 208. In other cases, upon detecting a fingerprint match, an indication that a matching fingerprint was detected may be provided to the event control 208. That is, rather than providing an identification of the specific matching fingerprint, an indication that a fingerprint match occurred may be provided.

The event control 208 is configured to initiate and/or perform events upon detection of a recognized audio content. In some embodiments, the event control 208, or a portion thereof, resides within an operating system of the user device 202. In other embodiments, the event control 208, or a portion thereof, functions in association with an application running on the user device 202. In one implementation, a content recognition application's code can include embedded code that is utilized to implement the functionality described in the event control 208, or a portion thereof. In another implementation, functionality of the event control 208, or a portion thereof, is performed by a stand-alone application that, for example, may be accessed or referenced by another program, such as another application running on the user device.

In operation, upon recognition of audio content, the event control 208 initiates one or more events. An event, as used herein, refers to any event or action that can be initiated upon recognition of audio content. By way of example only, and without limitation, an event may refer to a launch of a particular application (e.g., a content recognition application), a display of content information, an audio presentation, a content recognition displayable or audible indicator (e.g., indicates that audio content was recognized), presentation of a website, performance of a search performed by a search engine, a display of an option to navigate to a particular website or application, a display of an advertisement, a display of a coupon, or any other action or display of data.

In cases of displayable information to display, the event control 208, or other component, can cause a representation of the displayable information to be displayed (e.g., content information, advertisements, coupons, etc.). This can be performed in any suitable way. The representation of the displayable information to be displayed can be album art (such as an image of the album cover), an icon, text, an advertisement, a coupon or discount, a promotion, a link, etc. For alternative or additional events, the event control 208 or other component can facilitate execution of such an intended event, such as opening or presentation of a website, an application, an alert, an audio, or the like.

In some cases, a particular event to initiate may be independent from the specific audio content recognized. That is, regardless of whether a first audio content is recognized or a second audio content is recognized, the event control 208 may initiate a particular event, such as launch of a content recognition application. In such an implementation, the content recognizer 214 may simply provide an indication that a fingerprint match was detected or may provide an indication of the recognized audio content (i.e., content information). By way of example only, assume that content recognition control 206 and event control 208 function as code embedded in a third-party content recognition application capable of running on the user device 202. Further assume that background listening for audio content is initiated even when the third-party content recognition application is not active. In such a case, upon recognizing audio content as corresponding with stored in the local fingerprint data store that is associated with the third-party content recognition application, the event control 208 may initiate launch of the third-party content recognition application.

In other cases, a particular event to initiate may be selected based on the specific audio content recognized. As such, the event control 208 can be configured to lookup, recognize, or otherwise identify an event to apply in association with recognition of a particular recognized audio content. In such an implementation, upon receiving content information from the content recognizer 214, the event control 208 may use the received content information, or a portion thereof, to identify a particular event to initiate for application to the user device 202. For instance, a first content may be associated with a first event, such launch of a content recognition application, and a second content may be associated with a second event, such as presentation of displayable information (e.g., content information that identifies the content, an advertisement, etc.). By way of example only, assume that content recognition control 206 and event control 208 function as code embedded in the operating system of the user device 202. Further assume that the background listening for audio content is initiated even when any third-party content recognition applications are not launched. In such a case, upon recognizing content stored in the local fingerprint data store that is associated with a third-party content recognition application, the event control 208 may initiate launch of the corresponding third-party content recognition application. Although selection of an event is described herein as a function of the event control 208, as can be appreciated, such a function can be performed by another component, such as content recognizer 214, for example, upon recognizing audio content.

In embodiments, the event control 208 may also facilitate or initiate modifying the power mode of the user device 202. In this regard, upon audio content recognition, the event control 208 may wake up the user device 202 to transition the user device 202, for example from a low-power mode to a full-power mode. For example, assume that content recognition is performed when a user device is in low-power mode. In such a case, upon recognizing audio content, the event control 208 might trigger the user device to be in a full-power mode.

As previously described, in some embodiments, the content recognition control 206 and/or the event control 208, or portions thereof, may be embedded into code of an application, such as a content recognition application. In such embodiments, a content recognition platform (e.g., a cloud platform) may be used to enable accessibility to the embeddable code that performs functionality of the content recognition control 206 and/or event control 208. That is, a developer of a content recognition application may access embeddable code via a content recognition platform so that the embeddable code can be includes in the code in the content recognition application. Any suitable method may be used to obtain the embeddable code.

In one embodiment, a content recognition platform enables the embeddable controls to be created as binary objects. Such a platform can have one or more portals through which developers can upload clips of audio that are wished to be recognized. Upon receiving the uploaded clips of audio, the content recognition platform can process the clips of audio and create an audio fingerprint(s) (e.g., a binary representation) for the local fingerprint data store. In some implementations, the content recognition service may sign the local database so that the content recognition platform and the content recognition application can both trust the database's integrity. Thereafter, a developer may obtain (e.g., download) and embed the available code (including the local database) as a resource in its content recognition application. Such embedded code can be obtained in any manner, such as by downloading the code through a portal of the content recognition platform, reception of the code, for example, via email, or the like. The local fingerprint database, along with the packaged code, facilitates content recognition on a variety of platforms. Such embeddable code provides a way for developers to facilitate recognition of audio content, accept triggers from a content recognizer, and/or create new experiences that are powered by audio content recognition, to name a few benefits.

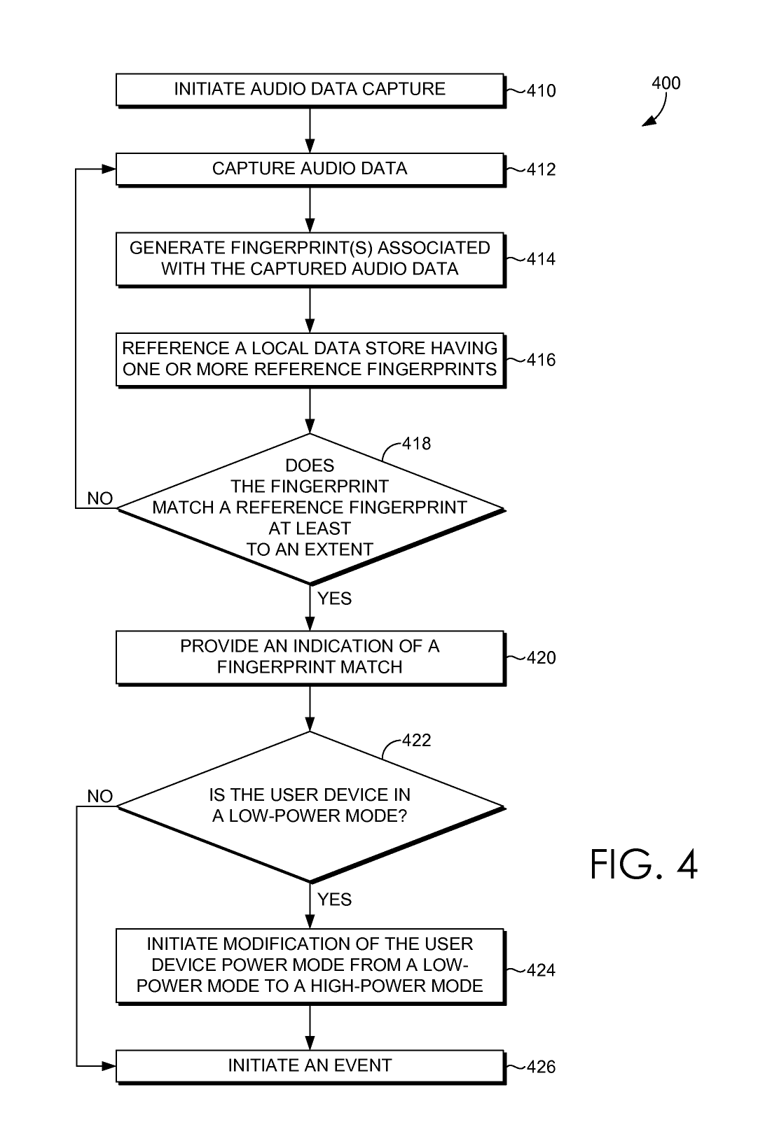

With reference to FIG. 4, a flow diagram is provided that illustrates an exemplary method 400 for facilitating local content recognition, in accordance with an embodiment of the present invention. Such a process may be performed, for example, by a user device, or a portion thereof, such as the user device 202 of FIG. 2. Initially, as indicated at block 410, audio data capture is initiated. For example, a listening manager, such as listening manager 210, can initiate capturing of audio data. At block 412, audio data is captured. In embodiments, audio data is stored in a buffer. At block 414, a fingerprint(s) associated with the captured audio data is generated. In some embodiments, the fingerprint(s) is generated using all the audio data stored in the buffer. In other embodiments, the fingerprint(s) is generated using a portion of the audio data stored in the buffer (e.g., a set of the most recently captured audio data, etc.). Such a fingerprint may be generated in response to an event, such as, for example, a user indication to identify content, a launch or utilization of a content recognition application, user interaction with the user device, a lapse of time interval, or the like.

At block 416, a local data store having one or more reference fingerprints is referenced. In this way, a data store within a user device that stores a set of fingerprints can be accessed. Such fingerprints within the data store can be obtained and/or designated in any number of ways. For instance, the fingerprints may be associated with a particular content recognition application or a set of content recognition applications.

At block 418, a determination is made as to whether the fingerprint(s) matches a reference fingerprint at least to an extent. In this way, it is determined whether the fingerprint(s) matches or substantially matches (e.g., exceeds a predetermined similarity threshold) any fingerprints in the local data store. If not, the method returns to block 412 at which audio data is captured. If so, at block 420, an indication of a fingerprint match is provided. For example, an indication of a fingerprint match might be provided to a content recognition application.

At block 422, it is determined if the user device is in a low-power mode. If the user device is in a low-power mode, modification of the user device power mode is initiated such that the user device transitions from a lower-power mode to a high-power mode. This is indicated at block 424. At block 426, an event is initiated. Returning to block 422, if it is determined that the user device is not in a low-power mode, the method proceeds to block 426, at which an event is initiated. Such an event may be, for example, display of content information, display of an advertisement, display of a coupon, display of a user option to present information or a website, presentation of a website, launch of an application, or the like.

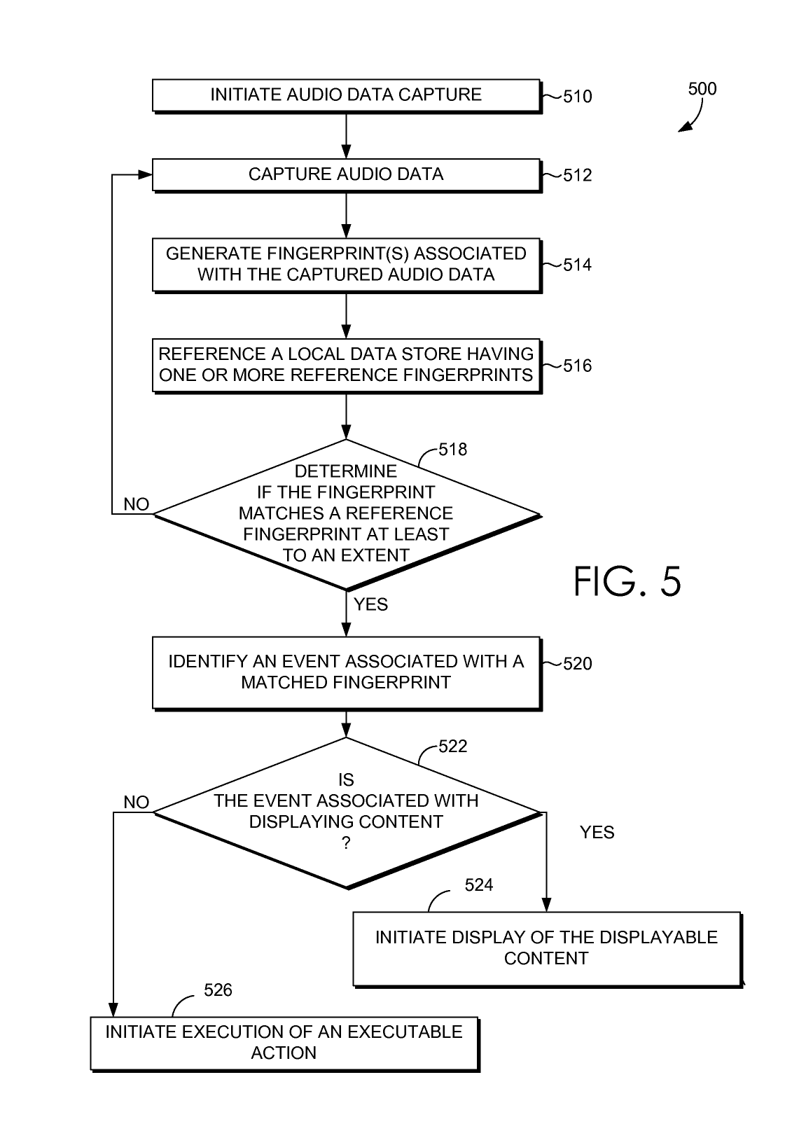

Turning to FIG. 5, a flow diagram is provided that illustrates an exemplary method 500 for facilitating local recognition of audio content, in accordance with an embodiment of the present invention. Such a process may be performed, for example, by an application(s) running on a user device, or a portion thereof, such as the user device 202 of FIG. 2. Initially, as indicated at block 510, audio data capture is initiated. For example, a content recognition application can initiate background listening and content recognition such that audio recognition can occur when the user device is in a low-power mode. At block 512, audio data is captured. In embodiments, audio data is stored in a buffer. At block 514, a fingerprint(s) associated with the captured audio data is generated. In embodiments, the fingerprint(s) is generated upon obtaining audio data or upon a lapse of a configurable setting, such as five seconds.

At block 516, a local data store having one or more reference fingerprints is referenced. In this way, a data store within a user device that stores a set of fingerprints can be accessed. Such fingerprints within the data store can be obtained and/or designated in any number of ways. For instance, the fingerprints may be associated with a particular content recognition application or a set of content recognition applications.

At block 518, a determination is made as to whether the fingerprint(s) matches a reference fingerprint at least to an extent. In this way, it is determined whether the fingerprint(s) matches or substantially matches (e.g., exceeds a predetermined similarity threshold) any fingerprints in the local data store. In embodiments, such a determination can be made upon generating an audio fingerprint, in response to a user indication, or upon a lapse of a configurable setting, such as five seconds. If a fingerprint match is not identified, the method returns to block 512 at which audio data is captured. If a fingerprint match is identified, at block 520, an event associated with the matched fingerprint is identified. In some implementations, the particular event might be based on the specific matched fingerprint. In other implementations, the particular event can be based on the occurrence of a fingerprint match.

At block 522, it is determined if the event is associated with displaying content or other executable action. If the event is associated with displayable content, at block 524, the display of the displayable content is initiated and/or caused. On the other hand, if the event is associated with another executable action, execution of the executable action is initiated. This is indicated at block 526.

As can be appreciated, in some embodiments, blocks 512, 514, 516, and 518 can be performed by an application or an operating system that is separate from an application performing the other steps. For example, a content recognition application can access another application or component performing the steps of 512, 514, 516, and 518 and, upon a content recognition at block 518, the content recognition application may be notified of such a recognition so that the content recognition application can initiate application of an event based on the content recognition.

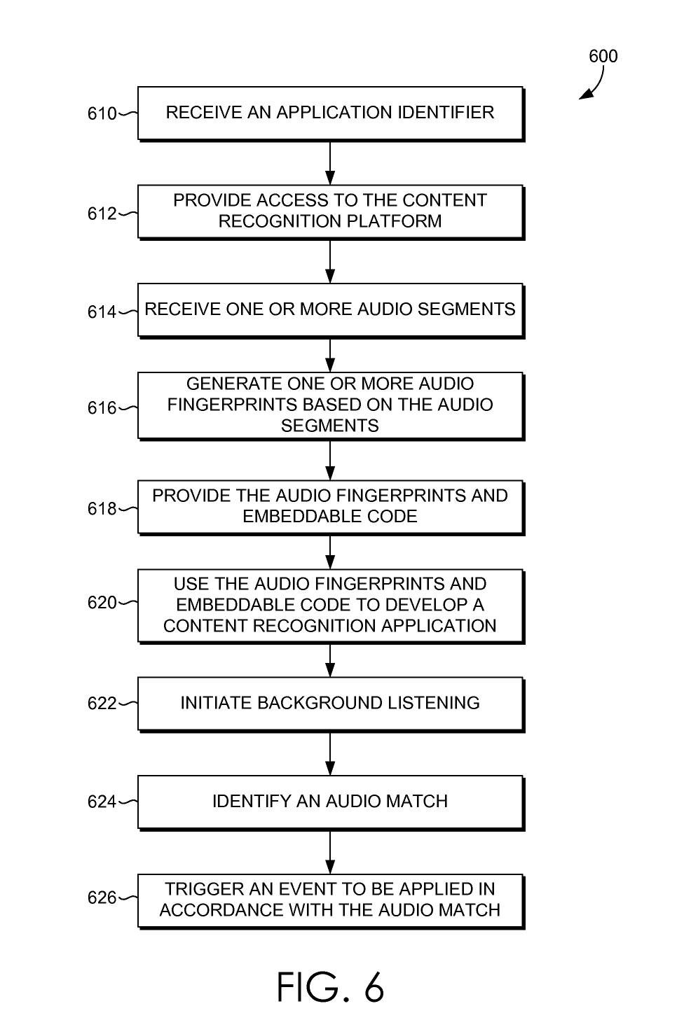

Turning to FIG. 6, a flow diagram is provided that illustrates an exemplary method 600 for facilitating local recognition of content, in accordance with an embodiment of the present invention. Such a process may be performed, for example, by a content recognition platform and/or a content recognition application. Initially, as indicated at block 610, an application identifier associated with a client is received. For example, a customer may provide an application identifier to access a content recognition platform. At block 612, provide access to the content recognition platform based on the received application identifier. At block 614, one or more audio segments are received. In this regard, the client may upload one or more audio segments to the content recognition platform to be used for content matching. At block 616, the audio segments are processed and one or more audio fingerprints are generated. Subsequently, at block 618, the one or more audio fingerprints and embeddable code, for example, that facilitates content recognition are provided. In this regard, the client may receive or retrieve (e.g., download) such audio fingerprint(s) and/or embeddable code. The audio fingerprints and embeddable code can be used to develop a content recognition application. This is indicated at block 620. At block 622, the content recognition application initiates continuous background listening. At block 624, the content recognition application identifies whether an audio match occurs, for example, at a configured interval. At block 626, if an audio match occurred, the audio recognition application triggers an event to be applied in accordance with the audio recognition.

As can be understood, embodiments of the present invention provide systems and methods for facilitating local recognition of audio content. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 400 of FIG. 4, method 500 of FIG. 5, and method 600 of FIG. 6 are not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. A computer-implemented method for facilitating local recognition of audio content at a user device, the method comprising:
capturing, using a user device, audio data, at least some of which is processable to recognize the audio data;
generating an audio fingerprint that uniquely represents perceptual information associated with the audio data;
referencing a local data store within the user device, the local data store including one or more reference audio fingerprints; and
determining that the generated audio fingerprint matches a reference audio fingerprint at least to an extent.

2. The method of claim 1, wherein the capturing occurs prior to receiving user input associated with a request for information regarding the audio data.

3. The method of claim 1, wherein the capturing occurs prior to launch of a content recognition application.

4. The method of claim 1, wherein the capturing occurs when the user device is in a low-power mode.

5. The method of claim 4, wherein generating the audio fingerprint, referencing the local data store, and determining that the generated audio fingerprint matches a reference audio fingerprint at least to an extent are performed when the user device is in a low-power mode.

6. The method of claim 5, wherein generating the audio fingerprint, referencing the local data store, and determining that the generated audio fingerprint matches a reference audio fingerprint at least to an extent are performed upon a lapse of a predetermined time period.

7. The method of claim 5 further comprising:
identifying content information associated with the audio data; and
causing display of the content information.

8. The method of claim 7 further comprising initiating modification of the user device from the low-power mode to a high-power mode.

9. The method of claim 1, further comprising identifying an event to apply in accordance with the determination that the generated audio fingerprint matches a reference audio fingerprint at least to an extent.

10. A mobile device comprising:
a microphone configured to facilitate audio data capture;
a listening control configured to store captured audio data in a buffer prior to receiving a user input associated with a request for information regarding the audio data;
a fingerprint generating component configured to generate fingerprints from the audio data;
a content recognizer configured to access a local data store containing a plurality of reference fingerprints and compare the generated fingerprints to one or more of the plurality of reference fingerprints to recognize the audio data.

11. The system of claim 10 further comprising an event control configured to initiate an event to occur upon recognition of the audio data.

12. The system of claim 11, wherein the event to apply is determined based on the recognition of the audio data.

13. The system of claim 12, wherein the event comprises one or more of display of content information, a launch of an application, display of a web page, display of a coupon, display of an advertisement, or a combination thereof.

14. The system of claim 11, wherein the event control is configured to initiate a full-power mode for the user device.

15. The system of claim 10, wherein one or more of the listening control, the fingerprint generating component, or the content recognizer component are configured to operate in a low-power mode applied to the user device.

16. One or more computer-readable storage media storing computer-useable instructions that, when used by one or more computing devices, cause the one or more computing devices to perform a method for facilitating local recognition of audio content, the method comprising:
initiating background listening to recognize audio content, wherein background listening comprises
continually buffering audio data and generating audio fingerprints from the buffered audio data, and
periodically determining if audio content is recognized using the generated audio fingerprints and a set of locally stored reference fingerprints;
receiving an indication of recognized audio content;
based on the recognized audio content, identifying an event to initiate; and
initiating the event.

17. The computer-readable storage media of claim 16 further comprising capturing the audio data for use in generating the fingerprints, computing the audio fingerprints, and performing the periodic determination of audio content recognition.

18. The computer-readable storage media of claim 17, wherein the periodic determination of audio content recognition occurs upon a lapse of a predetermined time duration.

19. The computer-readable storage media of claim 16, wherein an event to apply comprises one or more of display of content information, a launch of an application, display of a web page, display of a coupon, display of an advertisement, or a combination thereof.

20. The computer-readable storage media of claim 16 further comprising initiating a change of device state from a low-power state to a high-power state based on the received indication of recognized audio content.
